(19) United States
(12) Patent Application Publication
(10) Pub. No.: US 2023/0067019 A1
(43) Pub. Date: Mar. 2, 2023

(54) METHODS, SYSTEMS, AND DEVICES FOR STREAMING VIDEO CONTENT UNDER DATA BUDGET CONSTRAINTS USING AVAILABLE ADAPTIVE BIT-RATE (ABR) TRACK INFORMATION

(71) Applicants: AT&T Intellectual Property I, L.P., Atlanta, GA (US); The University of Connecticut, Farmington, CT (US)

(72) Inventors: Subhabrata Sen, Westfield, NJ (US); Bing Wang, Storrs Mansfield, CT (US); Yanyuan Qin, Storrs Mansfield, CT (US)

(73) Assignees: AT&T Intellectual Property I, L.P., Atlanta, GA (US); The University of Connecticut, Farmington, CT (US)

(21) Appl. No.: 17/463,820

(22) Filed: Sep. 1, 2021

(51) Int. Cl. H04L 29/06

(52) U.S. Cl. CPC H04L 65/80; H04L 65/608

(57) ABSTRACT

Aspects of the subject disclosure may include, for example, obtaining data budget for a communication session, identifying video content associated with the communication session, and determining a group of segments associated with the video content. Further embodiments can include determining a segment size for each of the group of segments, identifying a base track for each segment of the group of segments based on the segment size for each segment of the group of segments and the data budget, and identifying a target track for each segment of the group of segments based on the base track for each segment of the group of segments, the segment size for each segment of the group of segments, and the data budget. Additional embodiments can include providing a request for the target track for each segment to a video content server over a communication network. Other embodiments are disclosed.

### FIELD OF THE DISCLOSURE

The subject disclosure relates to methods, systems, and devices for streaming video content under data budget constraints using available adaptive bit-rate (ABR) track information.

### BACKGROUND

Over-the-top (OTT) mobile video content streaming is extremely popular, already accounting for the bulk of traffic on cellular networks. Video content streaming can be bandwidth intensive and can place a heavy demand on users' limited monthly cellular data budgets. As an example, streaming one-hour of Standard Definition (SD) quality video on Netflix uses about 1 GB of data while 1 hour of High Definition (HD) quality video on Netflix can consume as much as 3 GB. Therefore, streaming video content can impose a significant demand on the usage of cellular data, which is a scarce resource. Thus, there is a need to develop technologies that can conserve cellular data usage associated with video content streaming. In addition, it is also important that the video content streaming session delivers a good viewing experience to ensure good user Quality of Experience (QoE).

However, this can be challenging to achieve especially when streaming over cellular networks, given both the relatively high bandwidth requirements of streaming video, and the highly dynamic cellular network conditions, which can exhibit high network bandwidth variability over time. There is a need for developing video content streaming solutions that can enable users to experience good video content streaming QoE while staying within their specific monthly data budgets. This is an important and practical problem because cellular data is a relatively scarce resource, while, as described above, streaming video has high bandwidth needs. Therefore, any video delivery capability that is parsimonious with the associated network data consumption while still delivering adequate quality can be valuable capability. It would enable users to stretch their monthly data budgets further, and allow them to consume more content within their data budgets with satisfactory QoE. In addition, reduced data usage per session translates to reduced load on the cellular network, and hence potentially better QoE for other users sharing the same cellular infrastructure.

Adaptive Bitrate (ABR) streaming (mainly using DASH and HLS protocols) has emerged as the de facto OTT video streaming technology in industry. In ABR video content streaming, for each video, the video content server creates an ABR track ladder, comprising of multiple ABR tracks, each encoding the same content, but differing in terms of frame rate, encoding bitrate, resolution, or perceptual quality. Each ABR track is further divided into a series of segments, each containing data for a few seconds' (typically 2-10 seconds) worth of playback. For each segment position in the video, the encoding bitrates and hence the perceptual quality generally progressively increase going from lower to higher tracks. During streaming playback, the ABR client streaming application (e.g., on a mobile phone) leverages an adaptation logic to dynamically determine which quality ABR track to request/fetch for each segment position in the video content based on available network bandwidth and other factors. For good QoE, the ABR client streaming application needs to account for and balance across the conflicting goals of maximizing quality, minimizing rebuffering, and minimizing quality changes. Today's ABR video content streaming strategies focus mainly on maximizing the QoE and much less on reducing the associated data usage. However, because mobile data is a relatively scarce resource, making more efficient use of data is important. Some mobile network operators and commercial video services provide users some kind of “data saver” options. Existing approaches in industry to reducing data usage are either service-based or network-based. A service-based data reduction approach is typified by a video service providing a user multiple options (e.g., “Good”, “Better”, “Best” options in popular streaming applications) via the client player user interface (UI). Further, users can choose an option with a lower data usage at the cost of lower quality experience. The selected option is mapped to a specific ABR track in the ABR track ladder, and the ABR track selection during playback is constrained to selecting from ABR tracks with quality/screen resolution/bitrates at or below that ABR track. In a network-based data reduction approach, a mobile network operator caps the maximum network bandwidth available to a video content session (e.g., communication session) to a fixed value (e.g., 1.5 Mbps), which indirectly has a similar effect of inducing the client player to limit its selection of segments to a specific ABR track and ABR tracks below it. Existing ABR adaptation schemes can focus primarily on maximizing the video quality under the network bandwidth constraints, and not on limiting data usage. In one example, given a user-specified target perceptual quality level, the scheme can attempt to deliver the ABR content at that target quality. Specifically, the scheme avoids selecting video segment variants (e.g., associated ABR tracks) whose qualities exceed the target quality, leading to bandwidth savings. However, the scheme in the does not use customer data usage as part of the ABR track selection optimization decision, and does not provide an explicit control on per-session data usage. With that scheme, for the same target video quality specified by the user, the amount of data downloaded for viewing one video content can be significantly higher than that for another video content. As an example, suppose the target perceptual quality is VMAF 80 (which is considered “Good” quality). Then for 2 different 8-min long video content, with the scheme, the data usage is up to 29 MB for one video and up to 258 MB for the other video (9× as high as that for the first video content).

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIGS. 2A-2E are block diagrams illustrating example, non-limiting embodiments of a system functioning within the communication network of FIG. 1 in accordance with various aspects described herein.

FIGS. 2F-2I depict illustrative embodiments of methods in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for obtaining data budget for a communication session, identifying video content associated with the communication session, and determining a group of segments associated with the video content. Further embodiments can include determining a segment size for each of the group of segments, and identifying a base track for each segment of the group of segments based on the segment size for each segment of the group of segments and the data budget. Additional embodiments can include identifying a target track for each segment of the group of segments based on the base track for each segment of the group of segments, the segment size for each segment of the group of segments, and the data budget, and providing a first request for the target track for each segment of the group of segments to a video content server over a communication network. Other embodiments are described in the subject disclosure.

One or more aspects of the subject disclosure include a communication device, comprising a processing system including a processor, and a memory that stores executable instructions that, when executed by the processing system, facilitate performance of operations. The operations can comprise obtaining data budget for a communication session, identifying video content associated with the communication session, and determining a group of segments associated with the video content. Further operations can comprise determining a segment size for each of the group of segments, and identifying a base track for each segment of the group of segments based on the segment size for each segment of the group of segments and the data budget. Additional operations can comprise identifying a target track for each segment of the group of segments based on the base track for each segment of the group of segments, the segment size for each segment of the group of segments, and the data budget, and providing a first request for the target track for each segment of the group of segments to a video content server over a communication network.

One or more aspects of the subject disclosure include a non-transitory, machine-readable medium, comprising executable instructions that, when executed by a communication device including a processor, facilitate performance of operations. The operations can comprise obtaining data budget for a communication session, identifying video content associated with the communication session, and determining a group of segments associated with the video content. Further operations can comprise determining a segment size for each of the group of segments, categorizing each segment of the group of segments by the segment size of each segment into one of a first quartile of segment size, a second quartile of segment size, a third quartile of segment size, and a fourth quartile of segment size, and identifying a base track for each segment of the group of segments based on the segment size associated with each segment of the group of segments and the data budget. Additional operations can comprise identifying a target track for each segment of the group of segments based on the base track for each segment of the group of segments, the segment size for each segment of the group of segments, and the data budget, and providing a first request for the target track for each segment of the group of segments to a video content server over a communication network.

One or more aspects of the subject disclosure include a method. The method can comprise obtaining, by a communication device including a processor, data budget for a communication session, identifying, by the communication device, video content associated with the communication session, and determining, by the communication device, a group of segments associated with the video content. Further, the method can comprise determining a segment size for each of the group of segments, categorizing, by the communication device, each segment of the group of segments by the segment size of each segment into one of a first quartile of segment size, a second quartile of segment size, a third quartile of segment size, and a fourth quartile of segment size, and identifying, by the communication device, a base track for each segment of the group of segments based on the segment size for each segment of the group of segments and the data budget. In addition, the method can comprise identifying, by the communication device, a target track for each segment of the group of segments based on the base track for each segment of the group of segments, the segment size for each segment of the group of segments, and the data budget, providing, by the communication device, a request for the target track for each segment of the group of segments to a video content server over a communication network, and receiving, by the communication device, a group of requested tracks for each segment of the group of segments from the video content server.

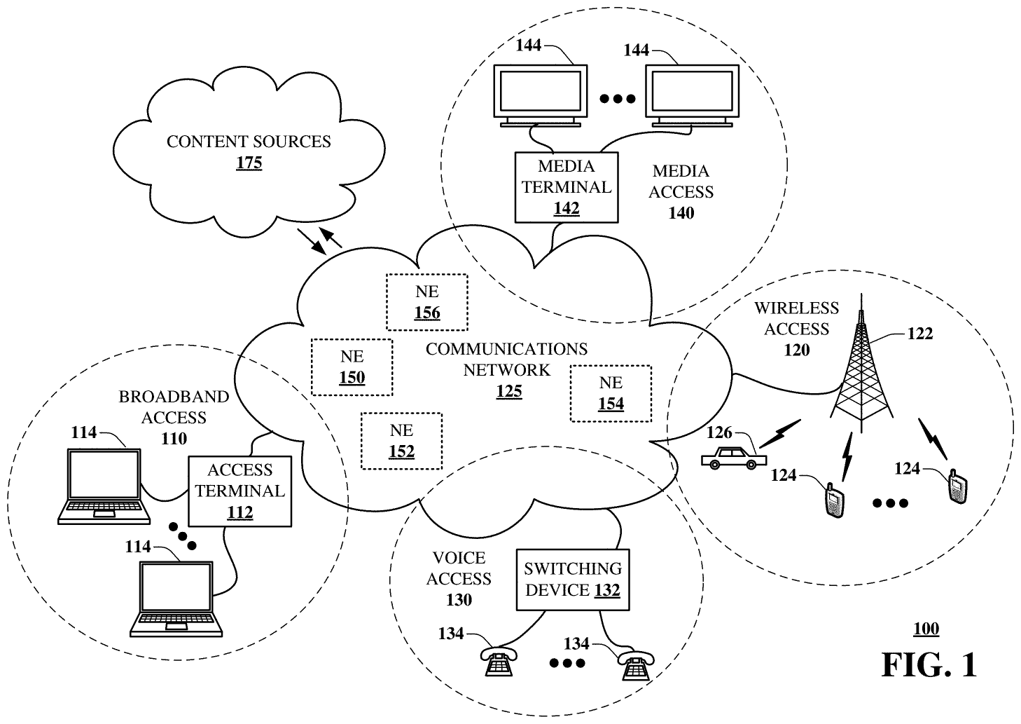

Referring now to FIG. 1, a block diagram is shown illustrating an example, non-limiting embodiment of a system 100 in accordance with various aspects described herein. For example, system 100 can facilitate in whole or in part streaming video content under data budget constraints using available ABR track information. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

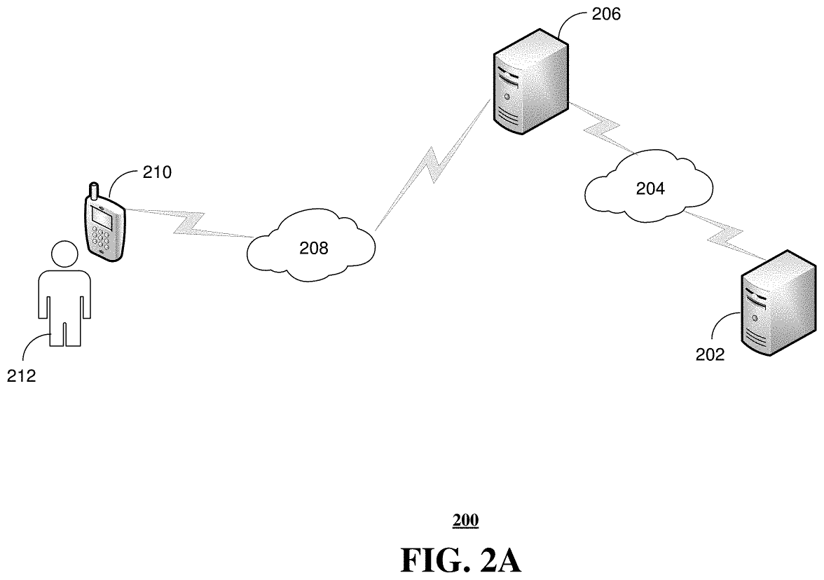

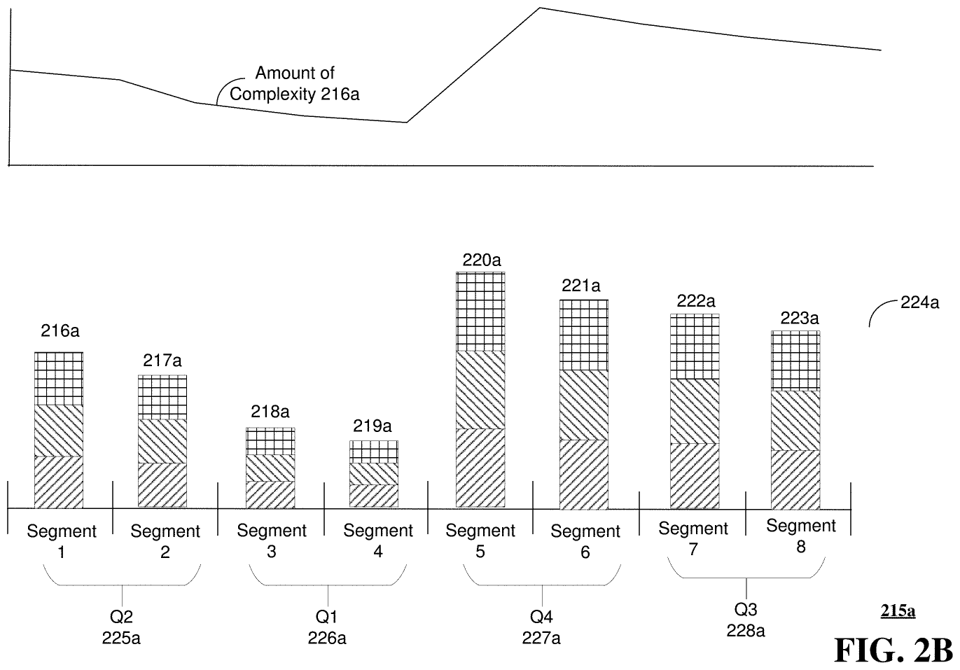

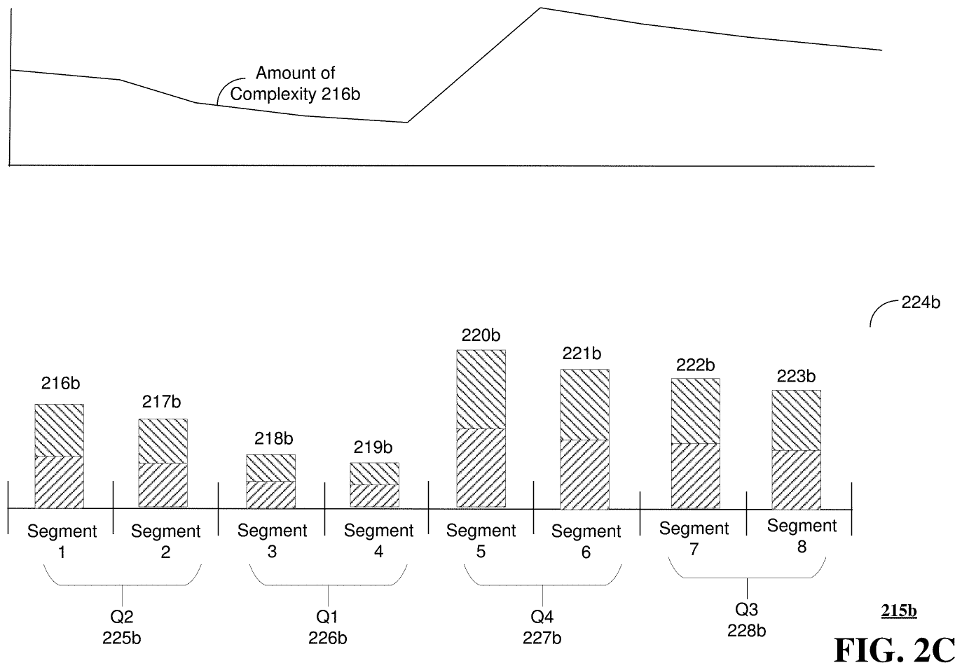

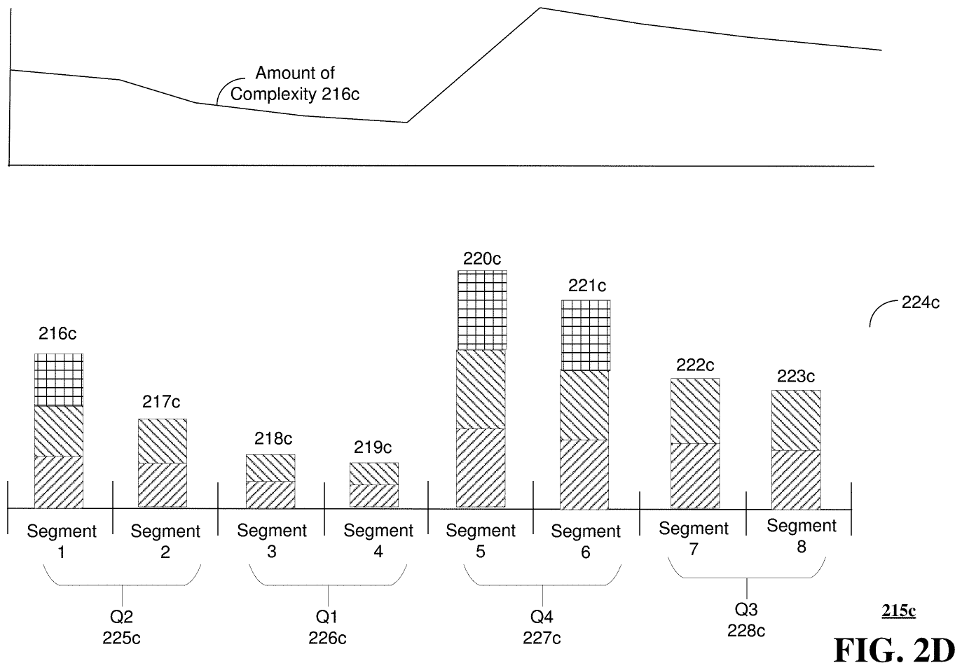

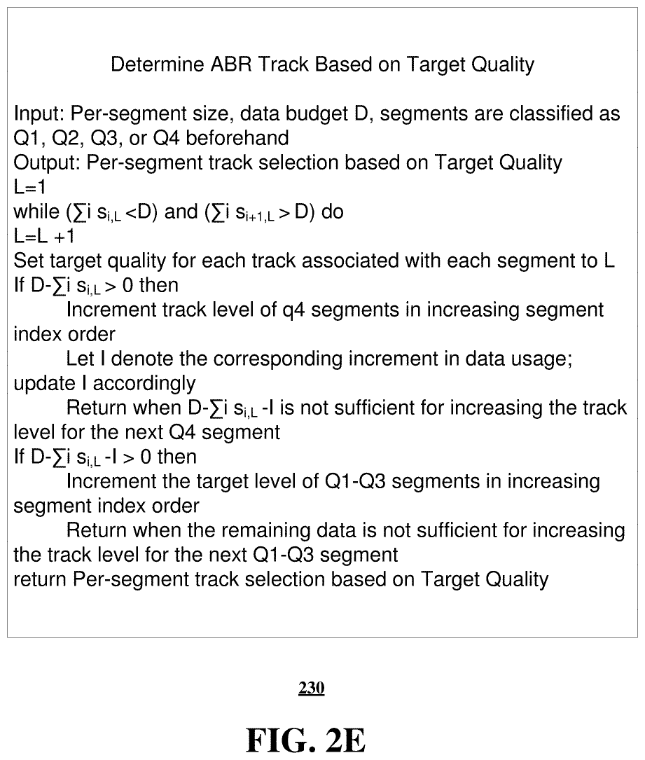

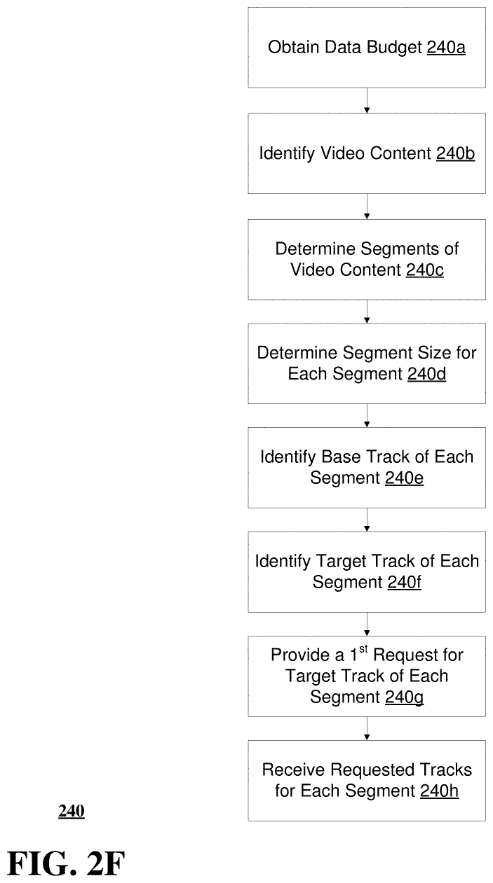

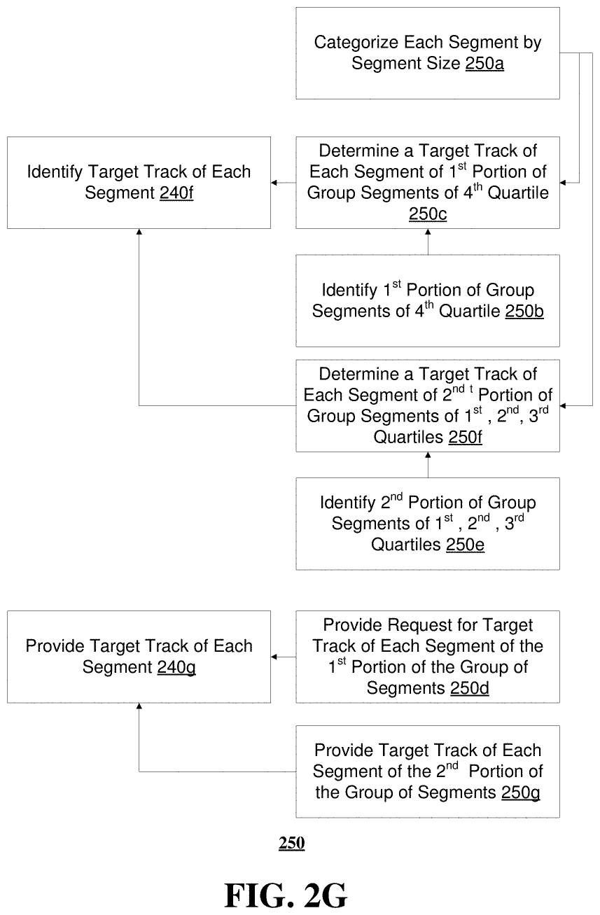

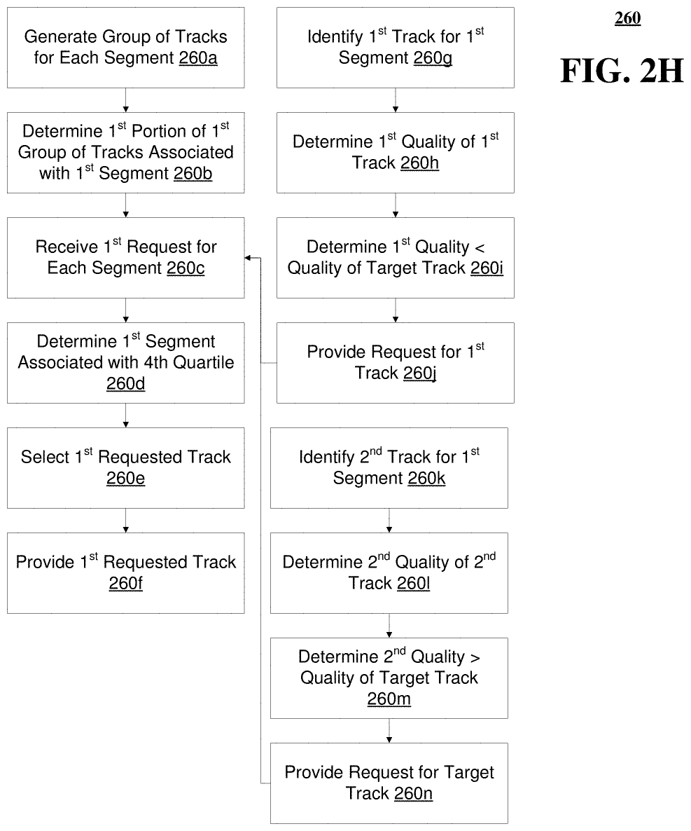

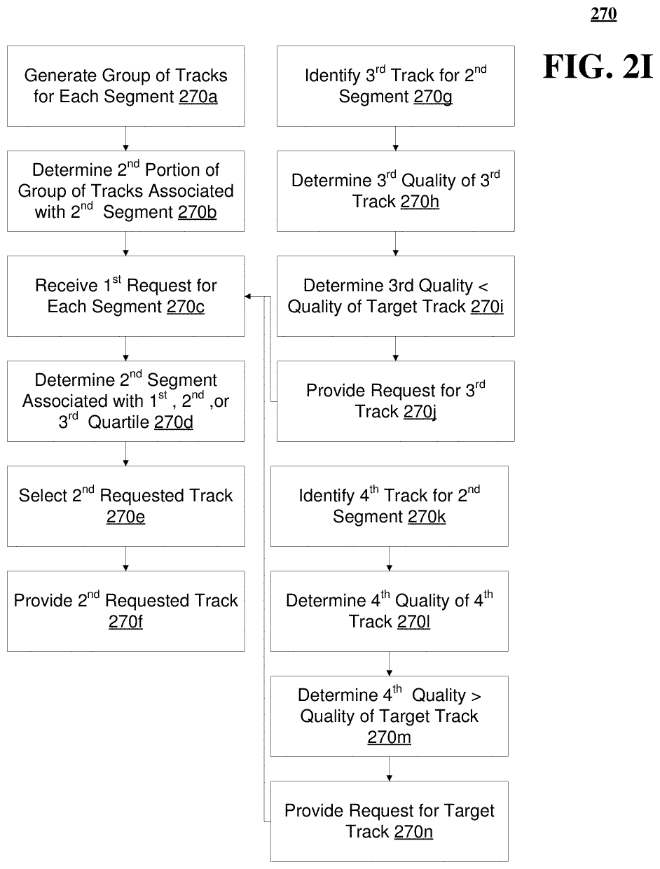

FIGS. 2A-2E are block diagrams illustrating example, non-limiting embodiments of a system functioning within the communication network of FIG. 1 in accordance with various aspects described herein. Referring to FIG. 2A, in one or more embodiments, the system 200 includes a video content server 202 communicatively coupled to a mobile network server 206 over a communication network 204. Further, system 200 comprises a communication device 210 associated with user 212 communicatively coupled to mobile network server 206 over communication network 208. Communication device 210 can comprise a mobile device, mobile phone, tablet computer, laptop computer, smartwatch, wearable device, augmented reality device, virtual reality device, or any other communication device. In addition, each of the video content server 202 and mobile network server 206 can comprise one server, multiple servers in one location, multiple servers spanning multiple locations, one or more virtual servers in one location or multiple locations, or one or more cloud servers. In some embodiments, the functions of the mobile network server 206 and the video content server 202 can be performed by one server, multiple servers, a virtual server, or multiple virtual servers. Also, each of communication network 204 and communication network 208 comprises a wireless communication network, a wired communication network, or a combination thereof. In some embodiments, some of the functions of the communication device and video content server can be performed by the mobile network server 206. Further, some functions of the video content server 202 can be performed by the mobile network server 206.

In one or more embodiments, a user 212 can explicitly selects a per-session data budget, and a data-budget constrained data planner application on the communication device 210 can bound the data consumption by that selected data budget. Overall, the prior existing solutions to limiting video streaming data usage can have difficulty in achieving a good balance between QoE and associated data usage, as they variously do not account for one or more important factors such as different video genres and encoding technologies, complexity and quality variability across different scenes in a video track, and different QoE vs. bitrate tradeoffs for different ABR track ladders. Further, they also do not consider overall data usage in making the ABR rate adaptation decision. Given the limitations of prior existing schemes, there is a real need for ABR adaptation solutions that explicitly consider the overall data usage and better balance the tradeoffs among video quality, rebuffering, quality changes, and bandwidth usage.

In one or more embodiments, a solution to this real need in the context of Adaptive Bitrate (ABR) streaming, the de facto over-the-top (OTT) video streaming technology in industry, can be implemented in a Video-on-Demand (VOD) use case, for example. Such embodiments can use the user's data budget information to better manage and limit the data usage of mobile video streaming while minimizing the impact on users' quality of experience (QoE) and still providing good QoE. The benefits include more efficient data usage while working in conjunction with the existing ABR client streaming application on the communication device 210. This makes it possible for the wide base of services with existing deployed ABR technologies to still benefit from such embodiments.

In one or more embodiments, the data planner application can be a component of the overall data-budget constrained ABR streaming architecture. The data planner application plays a role in dynamically tracking the data usage and unused remaining data budget over time, rationing data usage by accounting for the remaining data budget and segments in a streaming session, steering the video track selection of the ABR client streaming application on the communication device towards delivering good QoE as well as revisiting and adapting its plans appropriately over the lifetime of the session. The data planner application needs to be designed carefully to reduce the adverse impacts on QoE when managing the streaming under a communication session's data constraint. A carefully designed data planner application would judiciously plan and ration the data budget across the session, subject to time-varying available network bandwidths across the communication session and varying content complexities across the video content streamed during the communication session, while steering the selection towards delivering good QoE.

In one or more embodiments, the data planner application can be designed for scenarios where the video client player on the communication device 210 does not have access to perceptual video quality information about the ABR track ladder that can be generated by the video content server 202. This can be a common case today, and most services today do not share video quality information about the ABR track ladder generated by the video content server 202 with the video client player running on the communication device 210. Therefore, the data planner application (running on the communication device 210) cannot rely on per-segment quality information and needs to use the available information around encoding bitrates and sizes for its decision process to achieve streaming with good QoE across the different video segments while satisfying the data budget constraints. Thus, the data planner application can track the data usage and unused remaining data budget over time, ration data usage by accounting for the remaining data budget and segments in a streaming communication session, steer the video track selection of the ABR client streaming application running on the communication device 210 towards delivering good QoE, and revisiting and adapting its plans appropriately over the lifetime of the communication session streaming the video content.

In one or more embodiments, the data planner application on the communication device 210 can work as follows. The data planner application can run periodically during a communication session that streams video content, each time determining a per-segment target track for each of the remaining video segment positions that have not yet been streamed from the video content server 202, considering the remaining available data budget. For example, consider a video of “n” segment positions and a communication session data budget “D” (running the data planner application in the middle of the session for the remaining outstanding segment positions and remaining data budget can be done similarly). While the ABR client streaming application on the communication device runs after each segment is downloaded to determine the ABR track for the next segment, the data planner application can run at a coarser time scale, e.g., every time interval or after every X segments have been downloaded. Let D denote the data budget (in bytes) for the communication session that streams the video content, which is selected by the user when the session starts (or can be determined by the communication device 210 by access the remaining data budget in a user's monthly subscription plan from a network device and then determines the data budget for the communication session using the remaining data budget and the historical information of usage of data during a communication session). The goal of the data planner application is to design data planning strategies so that the total data consumed (application-level data) is bounded by D while still maintaining good QoE. At the beginning of the communication session, the data planner application determines the target track for each segment based on the total data budget and per-segment size. The target track Lᵢ for segment “i” represents an upper bound on the track for that segment, which is then used in conjunction with the ABR client streaming application to ensure that the selected track for segment “i” does not exceed Lᵢ to satisfy the data budget constraint. Each time it runs, the data planner application can calculate the remaining data budget as the total data budget subtracted by the amount of data that has been consumed until then, and dynamically adjusts the target track for each remaining segment position. Assume that at time t, when the data planner application runs, there are “n” remaining segments left in the video content that have not yet been streamed from the video content server 202, and the remaining available unused data budget for the session is “D”. D=total data budget limit for the session—cumulative data already consumed in the session up to time t. When per-segment quality is available, the data planner application can explicitly take account of the quality information to achieve similar quality across the segments while satisfying the data budget constraint.

In one or more embodiments, most services today do not share such quality information with the client. In such embodiments, the data planner application cannot rely on per-segment quality information and needs to use the available information around encoding bitrates for its decision process. For such embodiments, per-segment quality information is not available to the video client player running on the communication device 210, such that the data planner application can use available track information in the ABR video manifest obtained from the video content server 202 (which is the only information the data planner application has to gauge quality). The manifest provides the data planner application with the available ABR tracks generated by the video content server 202 for each segment of the video content including the size (in bits, bytes, etc.) of available ABR tracks to determine the size of each segment of the video content. Further, the data planner application directly determines per-segment target quality associated with the tracks for the remaining segments based on the size of each segment. In some embodiments, the data planner application sets the target track for segments associated with complex scenes (i.e., high-motion or high-complexity scenes) to a higher track level (e.g., higher quality) than those for the simple scenes (i.e., low-motion or low-complexity scenes). This is based on insight that: (i) depending on scene complexity, segments in the same track can have very different qualities, and (ii) even for Variable Bit Rate (VBR) encoding where complex scenes are encoded with more bits, they still tend to have lower quality than simple scenes. For VBR encoding, since it has been widely adopted by industry due to their many advantages over Constant Bit Rate (CBR) encoding, the data planner application differentiates the segments containing complex and simple scenes based on their relative sizes as follows: (1) specifically, in one embodiment, the data planner application identifies the segments containing complex scenes as those with sizes falling in the largest quartile of all the segments in the track, referred to as Q4 segments; and (2) identify the rest of the segments that falling into the lower three quartiles, referred to as Q1-Q3 segments, as containing simple scenes. For the example below, it is assumed the above method of classification of segments into 4 categories, however, the segments can be quantified in more or less than four categories of segment size. Further, the above is one possible approach to differentiating the segments containing complex and simple scenes. Other categorization schemes are possible that can result in the same or different numbers of categories, and the data planner application can work with such categorization schemes.

In one or more embodiments, the data planner application works on the communication device 210 as follows. Assume that at time t, when the data planner application runs, there are “n” remaining segments left in the video content that have not yet been streamed from the video content server 202, and the remaining available unused data budget for the communication session is “D”. D=total data budget limit for the session—cumulative data already consumed in the session up to time t. Further, the data planner application can classify the segments of the video content as Q1, Q2, Q3 or Q4 (e.g., first quartile, second quartile, third quartile, and fourth quartile of segment size) at the beginning of the communication session that streams the video content based on their sizes. In addition, the data planner application can determine the highest track level “1” such that that the total data requirement across all the segments in track “l”, sum {s(i,l)}<=D, where s(i,l) is the size of the ith segment in track level “l” (l<=I<=n). This track “l” can be referred as the “base track”. Also, the data planner application can initially set the target track for all segments in the video content to this base track. Further, the data planner application can seek to increase (i.e., improve) the target track for each Q4 segment (i.e., the segments with the most complex scenes) when possible. Specifically, if D—sum {s(i,l)}>0, i.e., the data budget D is not being fully used up by streaming track “1”, then the unused slack in the data budget (i.e., D—sum {s(i,l)}) is used to increase the target track(s) by one level for the Q4 segments. The increment can be done in increasing order of playback position of the Q4 segments within the n segments, and stops when either the target track(s) for all the Q4 segments have been incremented or the data budget has been exhausted. In addition, if the data budget is still not used up, then the remainder of the budget can be used to increment the tracks associated with Q1-Q3 segments of the video content from their respective base tracks in the increasing order of the segment index.

Referring to FIGS. 2B-2D, illustrates the actions by the data planner application described above. Referring to FIG. 2B, for example, the video content server 202 can provide video content information regarding segments of the video content, the size of each segment, and the ABR tracks that are available from or generated by the video content server 202 for each segment. For example, the video content can comprise eight segments 216a, 217a, 218a, 219a, 220a, 221a, 222a, 223a. The data planner application can categorize segments 220a, 221a as Q4 segments (e.g., segments that fall in the fourth quartile of segment size), and the can categorize the remaining segments 216a, 217a, 218a, 219a, 222a, 223a as Q1 segments, Q2 segments, or Q3 segments (e.g., segments that fall in the first quartile, second quartile, or third quartile of segment size) based on segment size. The video content information can indicate that each segment can have up three tracks (e.g., levels), respectively. Referring to FIG. 2C, the data planner application on the communication device 210 can determine that a base track for each segment can be the second track level that is the highest track level such that the total data usage is below the data budget D. The data planner application can assign initially set the second track level as the target track for all the segments in the video content. Referring to FIG. 2D, the data planner application can determine the remaining unused data budget, and increase the target track for the two Q4 segments 220c, 221c to then assign the third level track for these segments, and then uses the still remaining unused data to increase the target track of the first segment 216c (which is a Q2 segment) to the third track level.

Referring to FIG. 2E, operation of can be summarized by algorithm 230. The output from data planner application on the communication device 210 can be a selection of a track for each remaining segment position based on segment size/quartile of segment size. This output is used to limit the track selection of the ABR client streaming application on the communication device 210 for each remaining segment “i” (1<=I<=n), as described below. In one or more embodiments, the data planner application interacts with the ABR client streaming application in two alternative ways: (i) apply the target track as a cap after the track selection made by the ABR client streaming application, referred as “cap afterwards”, and (ii) restricting the set of tracks to be selected by the ABR client streaming application through the target track, i.e., if the target track for segment index i is L(i) as determined by data planner, then only tracks 1 to L(i) are considered by the ABR client streaming application, referred as “cap beforehand”. In both embodiments, the data planner application treats the ABR client streaming application as a blackbox, and interacts with the ABR client streaming application through well-defined APIs. This allows the data planner application to be easily retrofitted into an existing systems that utilize ABR client streaming applications.

In one or more embodiments, the data planner application on the communication device 210 can be run periodically to recalculate the target track and the selection of tracks based on the recalculated target track. In one embodiment, the data planner application can be run periodically, after every Delta seconds (e.g., Delta=20 seconds). In another embodiment, the data planner application can be run after N>=1 segments have been downloaded (e.g., N=5 segments). The data planner application can provide a streaming video delivery capability that is parsimonious with the associated network data consumption while still delivering adequate quality. Such capability is valuable to any video streaming service and/or network provider that wants to support: (i) ABR streaming video over the network; and (ii) is interested at delivering robust high quality user experience, and making efficient use of network resources. The data planner application can enable users to stretch their data budgets further, and allow them to consume more content within their data budgets with satisfactory QoE. In addition, reduced data usage per session translates to reduced load on the cellular network, and hence potentially better QoE for other users sharing the same cellular infrastructure. Reduced network data usage also leads to lower radio energy consumption, lower device resource usage and therefore and lower heating on mobile devices. Evaluations across a wide range of cellular network conditions, using different video content covering diverse content types, codecs, and ABR track ladder settings demonstrate that the data planner application can successfully balance QoE while satisfying the data budget constraint. The corresponding achieved QoE is close to that of running the original state-of-the-art ABR schemes in standalone mode, but with substantially lower data usage.

Referring to FIG. 2A, in one or more embodiments, the communication device 210 associated with user 212 can stream video content from video content server 202 via communication network 204 and communication network 208 and mobile network server 206. Prior to streaming the video content from video content server 202, the communication device 210 can obtain a data budget for the communication session. The communication device 210 can obtain the remaining data budget of the user's monthly subscription plan from a network device from which it can access such data or from its memory that stores such data. Further, the communication device 210 can calculate the data budget for the communication session from the remaining data budget of the user's monthly subscription. For example, the communication device 210 can obtain and use historical information regarding the user's frequency of streaming video content during a communication session within a month, the length of such communication sessions, and the amount of data consumed during such communication sessions.

In one or more embodiments, the communication device 210 can identify the video content associated with the communication session to be streamed from the video content server 202. A user, via a user interface, can identify the video content to be streamed associated with a streaming platform or video-on-demand platform. Further, the communication device 210 can determine a group of segments associated with the video content and determine a segment size for each segment of the group of segments. The segment size for each segment can be provided by a manifest file from the video content server 202 that lists the available ABR tracks for each segment (and the size (e.g., in bits, bytes, etc.) of each available ABR track) and the segment size can be discerned or determined from the available ABR tracks for each segment. The segment size can be proportional or related to the amount of complexity of each segment that comprises scene that are high-action (e.g., car chases, etc.) or low-action (e.g., dialogue, etc.). High-action scenes have a higher amount of complexity than low-action scenes such that segments that include high-action scenes can be larger in segment size than segment that include low-action scenes. In some embodiments, the communication device 210 can determine the types of scenes (e.g., high-action, low-action, etc.) within a segment from accessing the metadata associated with the segment.

In one or more embodiments, the communication device 210 can identify a base track for each segment of the video content based on the segment size associated with each segment and the data budget for the communication session. Further, the communication device 210 can determine an ABR base track for each segment of the video content. In addition, the communication device 210 can determine the amount of data that would be consumed by the base track for each segment. The data planner application on the communication device 210 subtracts the amount of data that would be consumed by the base track for each segment from the data budget associated with the communication device. If there is any remaining data budget for the communication session, the communication device 210 can identify a target track for each segment of the video content (that can be higher than the base track) based on the base track and the (remaining) data budget associated with the communication session. In some embodiments the target track for a segment of the video content can be the same as the base track while in other embodiments the target track for a segment of the video content can be higher than the base track. The communication device 210 can provide a request (or group of requests) for the target track for each segment of the video content to the video content server 202 over communication network 208 and over communication network 204 via mobile network server 206. The video content server 202 can select an ABR track for each segment of the video content based on the request provided by the communication device 210.

In one or more embodiments, the communication device 210 determining the segment size for each segment of the group of segments associated with the video content can comprise categorizing each segment of the group of segments by the segment size of each segment into one or a first quartile of segment size, a second quartile of segment size, a third quartile of segment size, and a fourth quartile of segment size. Further, the identifying of the target track for each segment by the communication device 210 can comprise identifying a portion of the group of segments associated with the fourth quartile of segment size and determining a target rack for each segment of the portion of the group of segments according to the (remaining) data budget. In addition, the providing of the request for the target track for each segment of the video content by the communication device 210 to the video content server 202 can comprise providing a request for the target track for each segment of the portion of the group of segments. In further embodiments, the identifying of the target track for each segment of the group of segments associated with the video content by the communication device 210 can comprise identifying another portion of the group of segments that are associated with the first quartile of segment size, the second quartile of segment size, or the third quartile of segment size, and determining the target track for each segment of this other portion of the group of segments according to the (remaining) data budget. Also, the providing of the request for the target track for each segment of the group of segment associated with the video content by the communication device 210 to the video content server 202 comprises providing a third request for the target track for each segment of this other portion of the group of segments to the video content server. In some embodiments, the providing a request for the target track for each of the group of segments associated with the video content by the communication device 210 to video content server 202 can comprise providing an indication of one or more ABR tracks of the video content to the video content server 202 to provide the communication device 210 during the communication session that streams the video content. The indication can be a message, signal, alert, or any other indication between the communication device 210 and the video content server 202.

In one or more embodiments, the video content server 202 generate a group of tracks for each segment of the group of segments associated with the video content. A first portion of the group of tracks can associated with a first segment of the group of segment. Further, the video content server 202 can receive a request for the target track for each segment of the group of segments. In addition, the first segment can be associated with the fourth quartile of segment size. Also, the video content can select a first requested track from the first portion of the group of tracks for the group of segments. The video content server 202 can provide the first requested track for the first segment to the communication device 210.

In one or more embodiments, the communication device 210 can identify a first track for the first segment. Further, the communication device 210 can determine a first quality associated with the first track and determine that the first quality associated with the first track is less than a quality associated with a target track associated with the first segment. The providing of the request for the target track for each segment of the group of segments comprises providing a request for the first track.

In one or more embodiments, the communication device 210 can identify a second track for the first segment. Further, determining a second quality associated with the second track, and determine the second quality associated with the second track is greater than a quality associated with the target track associated with the first segment resulting in a first determination. The providing of the request for the target track for each of the group of segments comprises providing a request for the target track associated with the first segment based on the first determination.

In one or more embodiments, a second portions of the group of tracks can associated with a second segment of the group of segments. The second segment can be associated with the first quartile of segment sizes, the second quartile of segment sizes, or the third quartile of segment sizes. The video content server 202 can select a second requested track from the second portion of the group of tracks for the second segment of the group of segments. Further, the video content server 202 can provide the send requested track for the second segment to the communication device 210.

In one or more embodiments, the communication device 210 can identify a third track for the second segment. Further, the communication device 210 can determine a third quality associated with the third track, and determine the third quality associated with the third track is less than a quality associated with the target track associated with the second segment. In addition, the providing of the request for the target track for each segment of the group of segments can comprise providing a request for the third track.

In one or more embodiments, the communication device 210 can identify a fourth track for the second segment. Further, the communication device 210 can determine a fourth quality associated with the fourth track, and can determine the fourth quality associated with the fourth track is greater than a quality associated with a target track associated with the second segment resulting in a second determination. Providing of the first request for the target track for each segment of the group of segment can comprise providing a request for the target track associated with the second segment based on the second determination.

In one or more embodiments, the communication device 210 can receive a group of requested tracks for each segment of the group of segments form the video content server 202.

FIGS. 2F-2I depict illustrative embodiments of methods in accordance with various aspects described herein. Referring to FIG. 2F, in one or more embodiments, method 240 can be implemented by a communication device described herein. Further, aspects of method 240 can be implemented by a data planner application, and/or ABR client video player/application running on the communication device. Method 240 can include the communication device, at 240a, obtaining data budget for a communication session. Further, the method 240 can include the communication device, at 240b, identifying video content associated with the communication session. In addition, the method 240 can include the communication device, at 240c, determining a group of segments associated with the video content, Also, the method 240 can include the communication device, at 240d, determining a segment size for each of the group of segments. Further the method 240 can include the communication device, at 240e, identifying a base track for each segment of the group of segments based on the segment size for each segment of the group of segments and the data budget. In addition, the method 240 can include the communication device, at 240f, identifying a target track for each segment of the group of segments based on the base track for each segment of the group of segments, the segment size for each segment of the group of segments, and the data budget. Also, the method 240 can include the communication device, at 240g, providing a first request (or group of requests) for the target track for each segment of the group of segments to a video content server over a communication network. The method 240 can include the communication device, 240h, receiving a group of requested tracks for each segment of the group of segments from the video content server over the communication network.

Referring to FIG. 2G, in one or more embodiments, method 250 can be implemented by a communication device described herein. The method 250 can include the communication device, at 250a, categorizing each segment of the group of segments by the segment size of each segment into one of a first quartile of segment size, a second quartile of segment size, a third quartile of segment size, and a fourth quartile of segment size. Further, the method 250 can include the communication device, at 250b, identifying a first portion of the group of segments associated with the fourth quartile of segment size. In addition, the method 250 can include the communication device, at 250c, determining a target track for each segment of the first portion of the group of segments according to the data budget. In some embodiments, the identifying, at 240f, of the target track for each segment of the group of segments comprises identifying, at 250b, a first portion of the group of segments associated with the fourth quartile of segment size, and determining, 250c, a target track for each segment of the first portion of the group of segments according to the data budget. The method 250 can include the communication device, at 250d, providing a second request for the target track for each segment of the first portion of the group of segments to the video content server. In further embodiments, the providing, at 240g, of the first request for the target track for each segment of the group of segments comprises providing, at 250d, a second request for the target track for each segment of the first portion of the group of segments to the video content server. The method 250 can include the communication device, at 250e, identifying a second portion of the group of segments associated with the first quartile of segment size, the second quartile of segment size, and the third quartile of segment size. Further, the method 250 can include the communication device, at 250f, determining a target track for each segment of the second portion of the group of segments according to the data budget. In additional embodiments, the identifying, at 240f, of the target track for each segment of the group of segments comprises identifying, at 250e, a second portion of the group of segments associated with the first quartile of segment size, the second quartile of segment size, and the third quartile of segment size, and determining, at 250f, a target track for each segment of the second portion of the group of segments according to the data budget. The method 250 can include the communication device, at 250g, providing a third request for the target track for each segment of the second portion of the group of segments to the video content server. In some embodiment, the providing, at 240g, of the first request for the target track for each segment of the group of segments comprises providing, at 250g, a third request for the target track for each segment of the second portion of the group of segments to the video content server.

Referring to FIG. 2H, in one or more embodiments, the method 260 can be implemented by a video content server and/or communication device described herein. The method 260 can include the video content server, at 260a, generating a group of tracks for each segment of the group of segments associated with the video content. Further, the method 260 can include the video content server, at 260b, determining that a first portion of the group of tracks is associated with a first segment of the group of segments. In addition, the method 260 can include the video content server, at 260c, receiving the first request for the target track for each segment of the group of segments. Also, the method 260 can include the communication device, at 260d, determining the first segment is associated with the fourth quartile of segment sizes. The method 260 can include the video content server, at 260e, selecting a first requested track from the first portion of the group of tracks for the first segment of the group of segments. Further, the method 260 can include the video content server, at 260f, providing the first requested track for the first segment to the communication device. The method 260 can include the communication device, at 260g, identifying a first track for the first segment. Further, the method 260 can include the communication device, at 260h, determining a first quality associated with the first track. In addition, the method 260 can include the communication device, at 260i, determining the first quality associated with the first track is less than a quality associated with a target track associated with the first segment. Also, the method 260 can include, the communication device, at 260j, providing a request for the first track. In some embodiments, the providing of the first request for the target track for each segment of the group of segments comprises providing a request for the first track. The method 260 can include the communication device, at 260k, identifying a second track for the first segment. Further, the method 260 can include the communication device, at 260l, determining a second quality associated with the second track. In addition, the method 260 can include the communication device, at 260m, determining the second quality associated with the second track is greater than a quality associated with a target track associated with the first segment resulting in a first determination. Also, the method 260 can include the communication device, at 260n, providing a request for the target track associated with the first segment based on the first determination. In some embodiments, the providing of the first request for the target track for each segment of the group of segments comprises providing a request for the target track associated with the first segment based on the first determination.

Referring to FIG. 2I, in one or more embodiments, method 270 can be implemented by a video content server and/or a communication device described herein. The method 270 can include the video content server, at 270a, generating a group of tracks for each segment of the group of segments associated with the video content. Further, the method 270 can include the video content server, at 270b, determining a second portion of the group of tracks is associated with a second segment of the group of segments. In addition, the method 270 can include the video content server, at 270c, receiving a request for a target track for each segment of the group of segments. Also, the method 270 can include the communication device, at 270d, determining the second segment is associated with one of the first quartile of segment sizes, the second quartile of segment sizes, and the third quartile of segment sizes. Also, the method 270 can the video content server, at 270e, selects a second requested track from the second portion of the group of tracks for the second segment of the group of segments. The method 270 includes the video content server, at 270f, providing the requested track for the second segment to the communication device. Further, the method 270 can include the communication device, at 270g, identifying a third track for the second segment. In addition, the method 270 can include the communication device, at 270h, determining a third quality associated with the third track. Also, the method 270 can include the communication device, at 270i, determining the third quality associated with the third track is less than a quality associated with a target track associated with the second segment. The method 270 can include the communication device, at 270j, provide a request for the third track. In some embodiments, the providing of the first request for the target track for each segment of the group of segments comprising provide a request for the third track. The method 270 can include the communication device, at 270k, identifying a fourth track for the second segment. Further, the method 270 can include, at 270l, determining a fourth quality associated with the fourth track. In addition, the method 270 can include the communication device, at 270m, determining the fourth quality associated with the fourth track is greater than a quality associated with a target track associated with the second segment resulting in a second determination. Also, the method 270 can include the communication device, at 270n, providing the first request for the target track associated with the second segment based on the second determination. In further embodiments, the providing of the first request for the target track for each segment of the group of segments comprises providing the first request for the target track associated with the second segment based on the second determination.

While for purposes of simplicity of explanation, the respective processes are shown and described as a series of blocks in FIGS. 2F-2I, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein. Further, one or more blocks can be implemented in response to one or more blocks.

Portions of some embodiments can be combined with portions of other embodiments.

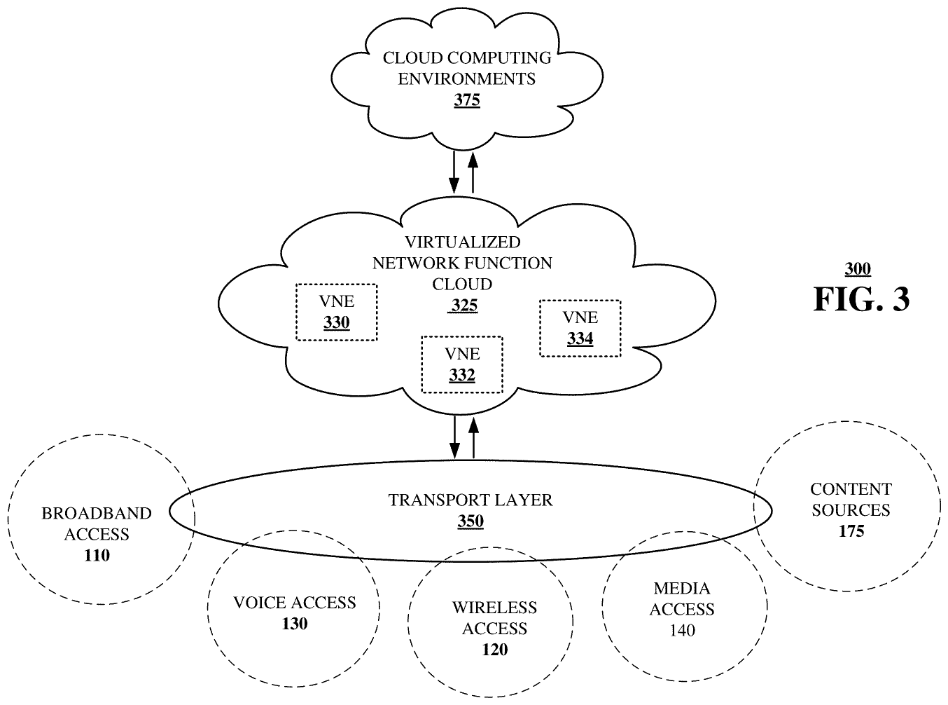

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of systems 200, 215a, 215b, 215c, 230 and methods 240, 250, 260, 270 presented in FIGS. 1, 2A-2I, and 3. For example, virtualized communication network 300 can facilitate in whole or in part streaming video content under data budget constraints using available ABR track information.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

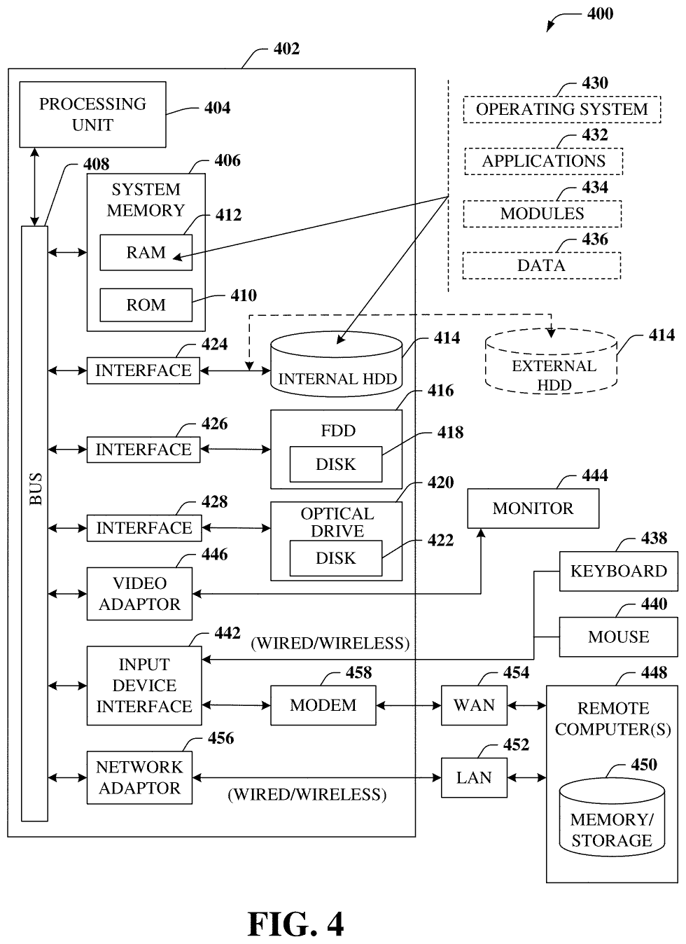

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part streaming video content under data budget constraints using available ABR track information. Each of video content server 202, mobile network server 206, and communication device 210 can comprise computing environment 400.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

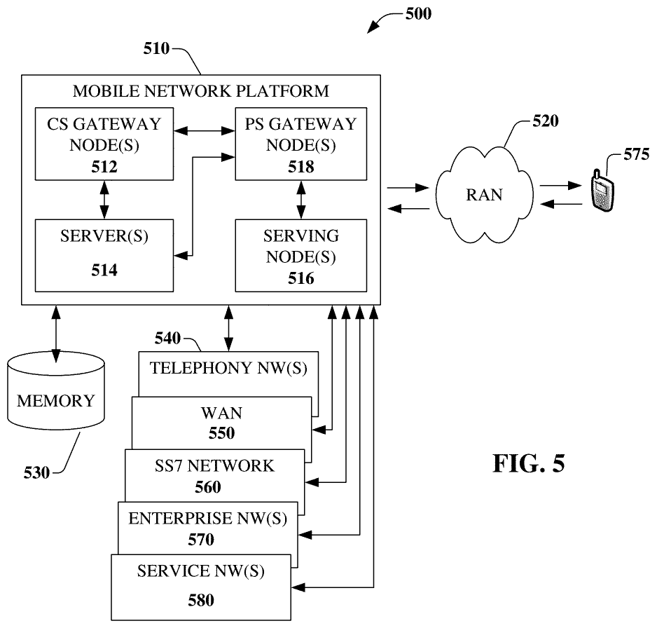

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part streaming video content under data budget constraints using available ABR track information. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It is should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

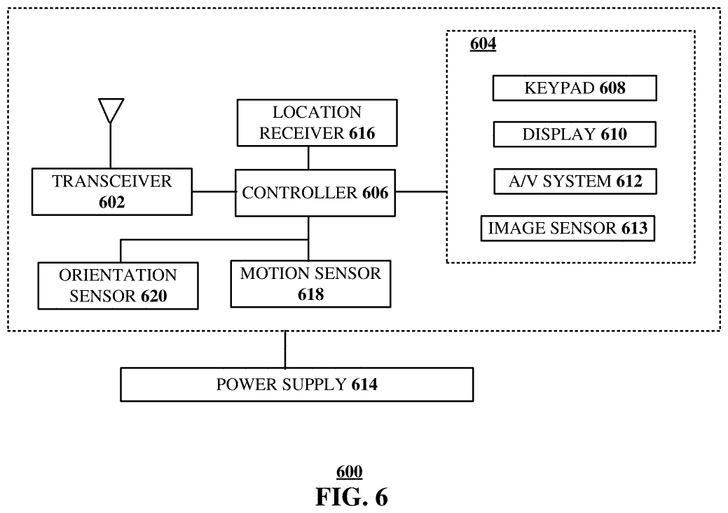

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, communication device 600 can facilitate in whole or in part streaming video content under data budget constraints using available ABR track information. Each of video content server 202, mobile network server 206, and communication device 210 can comprise communication device 600.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A communication device, comprising:
a processing system including a processor; and
a memory that stores executable instructions that, when executed by the processing system, facilitate performance of operations, the operations comprising:
obtaining data budget for a communication session;
identifying video content associated with the communication session;
determining a group of segments associated with the video content;
determining a segment size for each of the group of segments;
identifying a base track for each segment of the group of segments based on the segment size for each segment of the group of segments and the data budget;
identifying a target track for each segment of the group of segments based on the base track for each segment of the group of segments, the segment size for each segment of the group of segments, and the data budget; and
providing a first request for the target track for each segment of the group of segments to a video content server over a communication network.

2. The communication device of claim 1, wherein the determining the segment size for each segment of the group of segments comprises categorizing each segment of the group of segments by the segment size of each segment into one of a first quartile of segment size, a second quartile of segment size, a third quartile of segment size, and a fourth quartile of segment size.

3. The communication device of claim 2, wherein the identifying of the target track for each segment of the group of segments comprises:
identifying a first portion of the group of segments associated with the fourth quartile of segment size; and
determining a target track for each segment of the first portion of the group of segments according to the data budget.

4. The communication device of claim 3, wherein the providing of the first request for the target track for each segment of the group of segments comprises providing a second request for the target track for each segment of the first portion of the group of segments to the video content server.

5. The communication device of claim 2, wherein the identifying of the target track for each segment of the group of segments comprises:
identifying a second portion of the group of segments associated with the first quartile of segment size, the second quartile of segment size, and the third quartile of segment size; and
determining a target track for each segment of the second portion of the group of segments according to the data budget.

6. The communication device of claim 5, wherein the providing of the first request for the target track for each segment of the group of segments comprises providing a third request for the target track for each segment of the second portion of the group of segments to the video content server.

7. The communication device of claim 2, wherein the video content server generates a group of tracks for each segment of the group of segments associated with the video content, wherein a first portion of the group of tracks is associated with a first segment of the group of segments, wherein a video content server receives the first request for the target track for each segment of the group of segments, wherein the first segment is associated with the fourth quartile of segment sizes, wherein the video content server selects a first requested track from the first portion of the group of tracks for the first segment of the group of segments, wherein the video content server provides the first requested track for the first segment to the communication device.

8. The communication device of claim 7, wherein the operations comprise:
identifying a first track for the first segment;
determining a first quality associated with the first track; and
determining the first quality associated with the first track is less than a quality associated with a target track associated with the first segment, wherein the providing of the first request for the target track for each segment of the group of segments comprises providing a request for the first track.

9. The communication device of claim 7, wherein the operations comprise:
identifying a second track for the first segment;
determining a second quality associated with the second track; and
determining the second quality associated with the second track is greater than a quality associated with a target track associated with the first segment resulting in a first determination, wherein the providing of the first request for the target track for each segment of the group of segments comprises providing a request for the target track associated with the first segment based on the first determination.

10. The communication device of claim 7, wherein a second portion of the group of tracks is associated with a second segment of the group of segments, wherein the second segment is associated with one of the first quartile of segment sizes, the second quartile of segment sizes, and the third quartile of segment sizes, wherein the video content server selects a second requested track from the second portion of the group of tracks for the second segment of the group of segments, wherein the video content server provides the second requested track for the second segment to the communication device.

11. The communication device of claim 10, wherein operations comprise:
identifying a third track for the second segment;
determining a third quality associated with the third track; and
determining the third quality associated with the third track is less than a quality associated with a target track associated with the second segment, wherein providing of the first request for the target track for each segment of the group of segments comprising provide a request for the third track.

12. The communication device of claim 10, wherein the operations comprise:
identifying a fourth track for the second segment;
determining a fourth quality associated with the fourth track; and
determining the fourth quality associated with the fourth track is greater than a quality associated with a target track associated with the second segment resulting in a second determination, wherein the providing of the first request for the target track for each segment of the group of segments comprises providing the first request for the target track associated with the second segment based on the second determination.

13. The communication device of claim 1, wherein the operations comprise receiving a group of requested track for each segment of the group of segments from the video content server over the communication network.

14. A non-transitory, machine-readable medium, comprising executable instructions that, when executed by a communication device including a processor, facilitate performance of operations, the operations comprising:
obtaining data budget for a communication session;
identifying video content associated with the communication session;
determining a group of segments associated with the video content;
determining a segment size for each of the group of segments;
categorizing each segment of the group of segments by the segment size of each segment into one of a first quartile of segment size, a second quartile of segment size, a third quartile of segment size, and a fourth quartile of segment size;
identifying a base track for each segment of the group of segments based on the segment size associated with each segment of the group of segments and the data budget;
identifying a target track for each segment of the group of segments based on the base track for each segment of the group of segments, the segment size for each segment of the group of segments, and the data budget; and
providing a first request for the target track for each segment of the group of segments to a video content server over a communication network.

15. The non-transitory, machine-readable medium of claim 14, wherein the identifying of the target track for each segment of the group of segments comprises:
identifying a first portion of the group of segments associated with the fourth quartile of segment size; and
determining a target track for each segment of the first portion of the group of segments according to the data budget.

16. The non-transitory, machine-readable medium of claim 15, wherein the providing of the first request for the target quality for each segment of the group of segments comprises providing a second request for the target track for each segment of the first portion of the group of segments to the video content server.

17. The non-transitory, machine-readable medium of claim 14, wherein the identifying of the target track for each segment of the group of segments comprises:
identifying a second portion of the group of segments associated with the first quartile of segment size, the second quartile of segment size, and the third quartile of segment size; and
determining a target track for each segment of the second portion of the group of segments according to the data budget.

18. The non-transitory, machine-readable medium of claim 17, wherein the providing of the first request for the target track for each segment of the group of segments comprises providing a request for the target track for each segment of the second portion of the group of segments to the video content server.

19. The non-transitory, machine-readable medium of claim 14, wherein the operations comprise receiving a group of requested tracks for each segment of the group of segments from the video content server.

20. A method, comprising:
obtaining, by a communication device including a processor, data budget for a communication session;
identifying, by the communication device, video content associated with the communication session;
determining, by the communication device, a group of segments associated with the video content;
determining a segment size for each of the group of segments;
categorizing, by the communication device, each segment of the group of segments by the segment size of each segment into one of a first quartile of segment size, a second quartile of segment size, a third quartile of segment size, and a fourth quartile of segment size;
identifying, by the communication device, a base track for each segment of the group of segments based on the segment size for each segment of the group of segments and the data budget;
identifying, by the communication device, a target track for each segment of the group of segments based on the base track for each segment of the group of segments, the segment size for each segment of the group of segments, and the data budget;
providing, by the communication device, a request for the target track for each segment of the group of segments to a video content server over a communication network; and
receiving, by the communication device, a group of requested tracks for each segment of the group of segments from the video content server.
